(19) United States
(12) Patent Application Publication
(10) Pub. No.: US 2006/0047753 A1
(43) Pub. Date: Mar. 2, 2006

(54) New online service offering email chat people location-in-a-dynamic-scenario, messagining, auctions and other services based upon real id of its subcribers

(76) Inventor: Dharam Pal, Hyderabad (IN)

Correspondence Address: Ramesh Babu Vishwanath, #48 Srt 1st Floor, Prakash Nagar, Begumpet, Hyderabad Andhra Pradesh, 500016, IN

(21) Appl. No.: 10/530,670

(22) PCT Filed: Oct. 27, 2003
(86) PCT No.: PCT/IN03/00343

§ 371 Date: Apr. 7, 2005

(30) Foreign Application Priority Data
Nov. 1, 2002 (SG) 200206571-2

(51) Int. Cl. G06F 15/16

(52) U.S. Cl. 709/206

(57) ABSTRACT

An online Service that provides REAL ID based services such as e-mail, chat, messaging, people-location-in-a-dynamic-scenario, auctions, dating, matchmaking etc. to its subscribers. It will also include all other services that may have to ride on REAL ID of subscribers. Subscribers include individuals, businesses, government agencies, etc. as Subscribers. The Service shall be operated by a Service Provider. Service Provider would carry out validation checks on prospects before inducting them as Subscribers. Service Provider shall be responsible for credentials of a Subscriber to the Service and shall be bear the onus of correctness of Subscriber's real life details i.e. name, age, sex, address etc. Service Provider shall charge Institutional Subscribers for usage of the services offered. Service Provider may/may not charge the individual Subscribers for the services provided.

Subscribers would find the Service more useful for carrying out formal/official communications from the Service with other Subscribers and non-Subscribers. Subscribers shall be able to make confidential comments in their e-mail communications that are meant only for the recipients in cc AND/OR BCC lists. Subscribers will also be able to locate and contact other Subscribers in a dynamic scenario. Communication services offered shall be more useful for formal/official communications as they will come to acquire legal sanctity. Thus, the Service will help facilitate productive deployment of internet technologies and provide greatest benefits to all concerned (individuals, businesses, government, judiciary and all others). To sum up, the Service will put to appropriate use all the ‘wires’ that internet technologies have provided in wiring-up the world.

### FIELD OF INVENTION

The present invention relates to following:
A new web based Service providing e-mail, chat, messaging, people-location-in-a-dynamic-scenario, auctions etc. services to its Subscribers based upon their REAL ID.
An improvement in the existing e-mail services and Applications whereby sender is able to add a confidential comment/message/narration etc. to an e-mail that is meant only for the recipients in the CC/BCC lists and a recipient in the CC/BCC list is able to receive and read the same.

### BACKGROUND OF THE INVENTION

1. Internet has the inherent strength of connecting people and achieve meaningful interaction among them. However, it seems to have come, and also stayed, without achieving that. Internet technologies have given us the ability to communicate with others in an instant. They also enable us to aggregate various forms of relevant data, information etc. in the required formats so that people could connect to each other regardless of the location.

2. However, desired benefits are not harnessed from such tremendous advancements made in this realm. We do not trust an electronic communication emanating, from current e-mail services i.e. Yahoo!, Hotmail etc., as we have no means of knowing who the owner is of that particular e-mail ID. Reason, there is a total lack of convergence between online processes and off-line processes. The virtual world and real world continue to co-exist with a Chinese wall dividing them. Without the convergence between the two the virtual world is not only incapable of bringing efficiencies and productivity gains but has also remained, and shall continue to be, exposed to myriad forms of abuses, frauds etc.

3. Currently, a stranger can send an e-mail to me from any of the universal e-mail service providers i.e. Yahoo!, Hotmail etc. with an ID, which is ‘apparently’ owned by me or by god or by . . . ! Similarly, one would never know the other person in a chat room! In addition, I cannot let people in my contact/address list (or people at large) know where I am on a particular date. I also cannot know if any of my contacts (or an unknown person) is available at a particular location on a particular date, if I needed help from someone at that location where I do not otherwise know anyone else. Similarly, I cannot let people in my contact list know that I am getting married or I have become a father or I am relocating or . . .

4. Both, my insurer and I are highly IT savvy. We receive/send several e-mails daily. However, with my current e-mail ID, from Yahoo!, I cannot instruct my insurance company to upgrade my medical protection plan. I have to ‘write in’!

5. Result, we have achieved the speed in communication sans the efficiency and productivity that, is expected to come with it. Situation is similar, in a way, to that of a pilot who knows how to fly the aircraft but has no sense of navigation.

6. Therefore, we have not been able to ‘wire-up’ the world despite having acquired all the wires that are needed to do so. Instead of connectivity, what we have is wrong connections where we have a father asking his daughter out for a date in a chat room! We see wrong connections all around leading to frauds, cheating and other criminal offences. Instead of us making use of the technology to our advantage we dance to the tunes of this technology.

7. Therefore electronic communications through these service providers lack authenticity and do not carry any legal sanctity. The online community is deprived of not only an electronic communication system that could be used for formal/official communications but also other functions i.e. people-location-in-a-dynamic-scenario, chat, messaging, auctions, dating, etc. that it can perform riding on the REAL ID of its Subscribers. Needless to mention immense benefits, in terms of productivity and efficiencies, that can be derived from such a Service by all concerned i.e. individuals, businesses, governments and other organisations etc.

8. All of us always strive to let people know how good we are, who we are, where we are etc., in our real life. We do that because we want to remain connected to people we would like to. However, the current online service providers have not come up with a service that caters to this basic human instinct. In the current scenario we end up telling what we are not, where we are not etc. Imagine a chat room where everyone knows who the rest are!

9. We will never be able to wire up people in real world but it is eminently possible to do so in the virtual world. There is a distinct possibility of connecting people, through internet, by converging online and offline processes, thus, achieving safe and productive online interaction among the online community. This will lead to users having the benefits that technology is supposed to deliver to them instead of being a victim of it.

### DESCRIPTION OF THE PRIOR ART

Real ID Based Services:

1. Currently anyone of us can get an ID from an e-mail service provider i.e. Yahoo!, Hotmail etc., that may read as bin.laden@yahoo.com, or george.bush@hotmail.com, or enron@lycos.com, or any other such ID. A user of these services is not only free to choose an ID of his choice but is also free to provide any fictitious personal details. In other words, a user is given license to wreck havoc online, which she does. A user can even open an e-mail account with any one of them under any ID for specific communications for a limited period and then, after doing the damage, terminate that account.

It is believed that some of the secret societies use these service providers' services to connect themselves and carryout their sinister plots. In effect, current service providers facilitate existence of sinister virtual states.

The same applies to other online communication services such as chat, messaging etc. Result, we have fraudulent/misleading communications, spam, virus spreading communications etc. Communications we could do well without.

2. Current service providers carry a feature that allows anyone to search for people. Firstly, the people search leads to fictitious IDs with irrelevant/non-descript/misleading profile information on the ID owner. Secondly, the search is in a static scenario where one gets to know only about a subscriber's permanent location, provided it is correct. It does not provide any information on where this person is on a given date or where this person will not be on a given date. Leading to either no-connectivity or wrong connectivity.

3. The current service providers have shied away from creating a REAL ID based e-mail, chat, messaging, people-location-in-a-dynamic-scenario, auctions etc. services either due to humongous amount of logistics that is involved in doing so or it has simply not occurred to them. It is understandable if two people located at two different places do not know (and cannot know) anything about each other in the physical world due to distances. However, in the online world it is eminently possible where all the technological and non-technological tools are available to overcome this difficulty. A fusion of internet technology and offline processes remains un-attempted. Hence, the trust and authenticity in communication is missing. A communication without authenticity is, to say the least, no communication.

Sender's Confidential Comment to the Recipients in the CC/BCC Lists:

1. E-mail is a powerful tool to communicate. One of the fundamental requirements about communication is clarity of communication. Lack of clarity in communication is worse than lack of communication. No news is good news! The lack of clarity leads to avoidable miscommunication and misunderstanding. More often than not, an e-mail recipient in CC/BCC list is not clear about the purpose for which the e-mail was forwarded to him/her. Especially so, in the corporate/business environment as prior series of email exchanges in the same thread were not considered appropriate to be forwarded to him/her.

2. None of the existing e-mail service providers (Yahoo!, Hotmail etc.) or Applications (Outlook Express, Outlook, Lotus Notes etc.) provides an option to the sender to add-in a confidential comment that is meant only for the recipient(s) in the CC/BCC lists explaining the purpose of forwarding that e-mail to them or incorporate any other comment that is relevant. The sender needs to compose a separate e-mail for this purpose to the recipients in the CC/BCC lists explaining the purpose of including them in the CC/BCC lists of recipients. May be, he/she has to send out separate emails to different sets of people explaining the purpose etc. This is an eminently avoidable duplication.

### SUMMARY OF THE INVENTION

1. It is an object of the present invention to provide a web based Service that provides various REAL ID based services i.e. e-mail, chat, messaging, people-location-in-a-dynamic-scenario, dating, matchmaking, auctions, etc. and other services that ride on a Subscriber's real world credentials. Both/all, the entities involved in a communication would exactly know who the other party is.

2. Another object of the present invention is to provide a feature whereby Subscribers of the Service can locate and contact other Subscribers, in a dynamic-scenario, on a given date or during a given period by age, sex, place of domicile, interests, hobbies etc.

3. Yet another object of the present invention is to provide an option to the sender of an e-mail to include a confidential comment meant only for the recipients in the CC/BCC lists and recipients of such e-mail in the CC/BCC lists to be able to open that comment and read it. Thereby eliminating the need for sender to compose a separate e-mail to the recipients in CC/BCC lists for the purpose of explaining why that e-mail was forwarded to them. Sender of such email shall be able to see list of all the recipients of email including BCC at any time after sending the mail, if he/she has retained a copy of the email in the ‘sent’ folder.

### DESCRIPTION OF THE PREFERRED EMBODIMENTS

1. Accordingly, in one aspect of the present invention consists in an online Service providing e-mail, chat, messaging, people-location-in-a-dynamic-scenario, auctions etc. online service. The Service includes as participants Subscribers (individuals, businesses and other organisations etc.) and the Service Provider, characterised in that as follows:
participating individuals as Individual Subscribers* to various services offered by Service Provider,
   *‘Individual Subscriber(s)’ refers to those Subscribers who have subscribed to the Service in their individual capacity.
participating businesses, organisations as Institutional Subscribers** to various services offered by Service Provider,
   **‘Institutional Subscriber(s)’ refers to those subscribers who have subscribed to the Service as businesses, organisations etc.

2. Service Provider does necessary due diligence/checks, on its own or through a third party validating agency, on a prospect before inducting a Subscriber to the Service and assigning a REAL ID;
Service Provider may forge necessary alliances with government agencies, banks etc. or seek their assistance in establishing a prospect's real world credentials to assign a REAL ID,
Service Provider may stipulate submission/verification of certain documents i.e. passport, identification card, driving licence, bank account pass books, credit card, birth certificate, employment certificate, business registration certificate or any such document that goes to establish real life credentials of the prospect before inducting him/her/it as a Subscriber and assigning REAL ID,
Service Provider bears the onus of correctness of Subscriber's credentials,
Service Provider shall put in place necessary mechanism(s) whereby a Subscriber's profile is updated whenever there is a change in the same; a Subscriber shall carry a part of this responsibility; if it is found out that a Subscriber had not made available the changes i.e. relocation etc. Service Provider shall be at liberty to terminate that Subscriber's account,

3. Service Provider collects sign-up, recurring etc. fees from Institutional Subscribers i.e. banks, insurance companies, universities, government departments etc. who need to make use of services offered i.e. receive e-mail communications from Subscribers; as recipients of such e-mails these organisations stand to benefit in terms of cost savings, efficiencies, productivity and avoidance of losses arising from fraudulent communications,
Service Provider may/may not collect sign-up, recurring etc. fees from Individual Subscribers,

4. Service Provider inducts Subscribers based upon their REAL ID and provides following services to them:
e-mail, chat, messaging, people-location-in-a-dynamic-scenario, auctions, dating/matchmaking etc. and any other service that needs to ride on Subscribers' REAL ID

5. Service Provider makes available certain mandatory portions i.e. name, age, sex (for Individual Subscribers only), location, contact particulars, contact person's name (for Institutional Subscribers only) etc. of Subscribers' profile in the public domain to which Subscribers have agreed to; Service Provider shall always retain the right to determine type of information, from Subscribers' profile, that may be made available in the public domain on mandatory basis,
Subscribers (both Individual Subscriber and Institutional Subscriber), however, have the option to make available greater details of their profile in the public domain,

6. The Service shall enable Subscribers to carry out following actions:
A) build their personal profile (in conformity with the actual particulars); Service Provider shall authenticate, in conformity with real world credentials of the Subscribers, the same before it is uploaded,
   update personal profile, this requires authentication by Service Provider,
   determine portions of their personal profile, other than mandatory information, that may be available to all the Subscribers,
   determine portions of their personal profile, other than mandatory information, that may be made available to other Subscribers who are in his contact list,
   create a dynamic profile based upon their travel plans and make it available either to all the Subscribers or the ones who are in his contact list; so that Subscribers in general or the ones in his contact list can locate him on a given date,
B) send e-mail to Subscribers/non-Subscribers; a Subscriber can send e-mail to only those non-Subscribers who are subscribed to usual e-mail service providers i.e. Yahoo!, Hotmail etc.; they shall not be able to send e-mail to institutions that have not subscribed to Service Provider's services; for instance if IBM has not subscribed to Service Provider's services then a Subscriber shall not be able to send e-mail to abc@ibm.com, as IBM has to join in as an Institutional Subscriber and pay a subscription fee to benefit from Service Provider's services,
   receive e-mails either only from the Subscribers or from Subscribers and Non-subscribers both,
   send e-mail with confidential comments that are meant only for the recipients in the CC/BCC lists,
C) chat with other Subscribers in general or the ones in his contact list in a chat room where everyone knows who the rest are,
   chat with non-Subscribers in a chat room where his/her real life details are known to everyone in the chat room; it is an option available to the Subscriber where he may choose to chat with non-Subscribers whose identities are not know to him/her whereas his identity is known to others in the chat room; currently only celebrities have the privilege of chatting in a chat room where others know who they are chatting with while the celebrity does not know others in the chat room,
D) indicate his availability/non-availability, to people in his contact list or to all the Subscribers, at his place of domicile,
   indicate the current location where he is available,
   indicate the future dates during which he will not be available at his place of domicile,
   indicate the location where he will be at a future date,
   allow people to contact him by e-mail, phone or any other means of contact,
E) search for people (in his contact list or otherwise) arriving at his place of domicile on a particular date by age, sex, place of domicile etc.,
   search for people (in his contact list or otherwise) who are/shall be at a particular location on a particular date by age, sex, place of domicile etc.,
   contact people, if they have provided their contact particulars in public domain, by e-mail, phone or any other contact particulars provided by them,
F) make announcements such as his relocation etc. to people in his contact list or to all the Subscribers,
   view such announcements, made by others in his contact list or by other Subscribers, by name, age, sex, relocation announcement, marriage announcement etc.,
   Institutional Subscribers can make/view relevant announcements i.e. forthcoming IPO, deny rumours in the market that are not true, new appointments etc. to Subscribers in their contact list,
G) make use of the other services i.e. messaging, auctions, matchmaking etc. that are provided by the Service Provider based upon Subscriber's REAL ID,
   Service Provider may add in other services that ride on Subscriber's REAL ID,

7. The proposed Service brings in accountability and authenticity to the actions taken by Subscribers through the Service, thus, it provides necessary safety online to all the Subscribers. The institutions such as banks, insurance companies, utilities, financial institutions and government agencies etc. shall join in as Institutional Subscribers; they shall be major recipients of such formal/official communications from their clients or business associates who have signed up as Subscribers to the service.

Individual Subscribers and Institutional Subscribers stand to derive huge benefits in the form of cost savings, efficiencies, avoidance of fraud and spam etc. Subscribers will not be required to write-in to other Subscribers. Typically, a written communication received by an, Institutional Subscriber is handled by a few hands, before it is disposed off. Proposed Service can be integrated to relevant department of the Institutional Subscriber for a particular type of communication i.e. a sales enquiry, which can thereafter be disposed off by relevant people through the Service or outside the Service.

Online communications emanating out of the Service, in the form of e-mail, messages or chat shall carry authenticity and shall be with recourse. Such communications may be given legal sanctity whereby a Subscriber, for instance, could give even fund transfer instructions to his bank, or an employer could carry out an interview with a job candidate through messaging/chat service. A judge in a court of law could even interrogate a witness through chat/messaging service.

Governments stand to benefit substantially from such services. Their e-government initiatives shall come to acquire necessary teeth as citizens making use of governments' services shall be identifiable.

In use, a Subscriber will visit the Service Provider's website and login to the Service by providing the assigned ID and password. Upon doing so, the community at large or the Subscribers in his contact list only would know that the Subscriber is online. The Subscriber can now send e-mail messages, read e-mail messages sent to him/her, chat, message, and locate people at a given location on a given date, locate locations where any of his known contact is there on a given date, update his personal/dynamic profile etc.

The Subscribers to the Service can carry out financial transactions such as auctions etc. This could be preferred mode of interaction as buyer and seller would know about each other. They will be engaging in a transaction with recourse in terms of other party's credentials.

Service Provider may forge alliances with other entities, which provide other online services i.e. online payment, b2c/b2b services, etc. so that these service providers could deliver their services riding on Service Provider's REAL ID based services. An alliance of this nature would bring greater comfort to other service providers and their users.

An example of such an alliance could be where www.e-bay.com stipulates that it would register only those users as sellers or buyers who have a REAL ID issued from the Service Provider, thus eliminating fraudulent transactions.

Implementation of the Service is a humongous task. It is likely that one single entity may not be able to provide the Service worldwide. There may be different entities carrying out the execution in different geographical locations, as they may be strong in that geographical region. However, they would all be integrated seamlessly into the overall Service. This may result into variation in level of scrutiny carried out of a prospect's credentials before inducting them as Subscribers. Service Provider shall be vigilant of these pitfalls and shall put in place necessary mechanism to address it.

Deployment possibilities of the proposed Service are infinite. Wherever authenticity of a communication and trusted identity is required, proposed Service can/shall be used. Hence, the Service Provider may be entering into several business alliances with other service providers etc. who could ride on Service Provider's services.

All the technologies, hardware or software, are already available to execute the proposed Service. No new technologies are to be developed etc. to implement it.

It is to be appreciated that the foregoing is illustrative and limiting of the invention, and that various changes and modifications described above will be apparent to those skilled in the art. Such changes and modifications can be made without departing from the spirit and scope of the present invention, and it is therefore intended that such changes and modifications be covered by the following claims:

1. An online Service, offering email, chat, messaging, people-location-in-a-dynamic-scenario, auctions etc. services, based upon REAL ID of its Subscribers comprising of a Service Provider as operator of the Service and individuals, businesses, organisations etc. as Subscribers wherein Service Provider shall do necessary validation checks on a prospect's real world credentials through their passport, driving license, birth certificate, identity card, business registration certificate or any other relevant document that helps in establishing their real world credentials before assigning them REAL ID and inducting as Subscriber,

2. An online Service according to claim 1 wherein Service Provider may engage services of a third party to carry out such validation checks on the prospect, may forge alliances or seek co-operation from government/quasi-government/private agencies to validate a potential Subscriber,

3. An online Service according to claim 1 wherein Service Provider shall have suitable mechanism in place to update a Subscriber's personal profile on an ongoing basis,

4. An online Service according to claim 1 wherein Service Provider shall bear the onus of correctness of a Subscriber's real life credentials that form part of Subscriber's personal profile and are available for viewing by all the Subscribers,

5. An online Service according to claim 1 wherein Service Provider shall stipulate certain mandatory information i.e. age, sex (for Individual Subscribers), location, contact particulars, contact person's particulars (for Institutional Subscribers) etc. that shall form part of a Subscriber's personal profile which shall be available in the public domain; Subscriber's personal profile shall be authenticated by the Service Provider before it is made available in the public domain; Any changes to a Subscriber's personal profile shall require Service Provider's authentication;

6. An online Service according to claim 1 wherein Subscribers to the Service shall have the option of making available further details about themselves in their personal profile in the public domain or to the other Subscribers who are in their contact list; Subscribers shall have the option of building a dynamic profile, apart from the personal profile of theirs that would indicate their availability on a given date,

7. An online Service according to claim 1 wherein Individuals, Businesses, Government Agencies, Organizations etc. join in as Subscribers upon validation of their real world credentials; Individuals join in as Individual Subscribers and businesses, organizations etc. join in as Institutional Subscribers,

8. An online Service according to claim 1 where Service Provider offers E-mail, messaging, chat, people-location-in-a-dynamic-scenario, auctions, dating, individual matchmaking, business matchmaking, business transactions, personal announcements etc. services to its Subscribers based upon their REAL ID; And any other online service(s) that riding on a Subscriber's REAL ID,

9. An online Service according to claim 1 where Service Provider offers a people location service in a dynamic scenario based upon its Subscribers' REAL ID enabling them to indicate their availability/non-availability, to people in their contact list or to all the Subscribers, at their place of domicile on a particular date; indicate the current location, to people in their contact list or to all the Subscribers, where they are available; indicate the future dates, to people in their contact list or to all the Subscribers, during which they will not be available at their place of domicile; indicate, to people in their contact list or to all the Subscribers, the location where they will be at a future date; allow people, in their contact list or to all the Subscribers, to contact them by e-mail, phone or any other means of contact; search for people (in their contact list or all the Subscribers) arriving at their place of domicile on a particular date by age, sex, place of domicile, interest, hobby etc.; search for people (in their contact list or all the Subscribers) who are/shall be at a particular location on a particular date by age, sex etc.; contact people, if they have provided their contact particulars, in public domain by e-mail, phone or any other contact particulars provided by them,

10. An online Service according to claim 1 wherein Subscribers can opt to receive e-mails only from other Subscribers of the Service; can send/receive e-mail to/from non-Subscribers who subscribe to traditional e-mail services i.e. Yahoo!, Hotmail etc. that are available for subscription to public either on free basis or fee basis; can not send e-mail to non-subscribing institutions,

11. An online Service according to claim 1 wherein Subscribers can opt to chat only with the Subscribers to the Service in a chat room; can opt to chat in a chat room with non-Subscribers where their REAL ID is known to the others while the Subscriber does not know others in the chat room,

12. An online Service according to claim 1 wherein Subscribers can make personal announcement i.e. birth of a child, relocation etc. to people in their contact list or to all the Subscribers to the Service; can search for announcements made by people in their contact list; can search for announcements made by any of the Subscriber to the Service by relocation, birth of a child, by place of domicile, name etc. categories; Institutional Subscribers too can make announcements such as forthcoming IPO, deny rumours in the market about their organisation etc.,

13. An online communication Service according to claim 1 wherein said Service Provider maintains a database of Subscribers, wherein each Subscriber has an ID (REAL ID), based upon Subscriber's real world credentials, provided by the Service Provider; which is held by the Service Provider and which must be provided by the Subscriber at Service Provider's web site when intending to use services provided on Service Provider's web site.

14. An online Service according to claim 1 where Service Provider charges Institutional Subscribers for usage of services offered; where Service Provider may/may not charge individual Subscribers for usage of services offered,

15. An online Service according to claim 1 where Service Provider may integrate a Subscriber's email a/c to his PDA/Mobile Phone or any such gadget,

16. An online Service according to claim 1 wherein Service Provider may integrate Subscriber's ID with other service providers who offer services similar or different from Service Provider's service viz. online auction service providers, online payment service providers or any other service provider who may need to ride on the REAL ID of the individual, institutions and business etc.

16. A functionality whereby a sender of an e-mail is able to incorporate a confidential comment, message or narration meant only for a particular recipients OR a group of recipients in the TO/CC/BCC list and such recipients of such e-mail is able to open and read the same in confidence. The functionality shall be made available to Users of e-mail services irrespective of email Applications, Systems etc.; Users of any kind of e-mail service or e-mail Application that enables them to send or receive an e-mail,

17. A functionality according to claim 16 whereby a user of the Service can view all the email addresses that were there in the BCC list of an email sent by him/her at a later date if he/she has retained a copy of the email in ‘sent emails’ folder,
